(19) United States
(12) Patent Application Publication
(10) Pub. No.: US 2021/0071570 A1
(43) Pub. Date: Mar. 11, 2021

(54) ACTUATOR FOR VARIABLE COMPRESSION RATIO MECHANISM OF INTERNAL COMBUSTION ENGINE

(71) Applicant: HITACHI AUTOMOTIVE SYSTEMS, LTD., Hitachinaka-shi, Ibaraki (JP)

(72) Inventors: Yoshihiro SUDA, Ebina-shi, Kanagawa (JP); Kishiro NAGAI, Atsugi-shi, Kanagawa (JP); Ken Bryan IKEGUCHI, Ayase-shi, Kanagawa (JP)

(73) Assignee: HITACHI AUTOMOTIVE SYSTEMS, LTD., Hitachinaka-shi, Ibaraki (JP)

(21) Appl. No.: 16/642,788

(22) PCT Filed: Sep. 5, 2018
(86) PCT No.: PCT/JP2018/032799

§ 371 Date: Feb. 27, 2020

(30) Foreign Application Priority Data
Sep. 14, 2017 (JP) 2017-176957

(51) Int. Cl. F02B 75/04; F02B 75/32

(52) U.S. Cl. CPC F02B 75/048; F02B 75/32

(57) ABSTRACT

Provided is an actuator for a variable compression ratio mechanism of an internal combustion engine, which improves productivity. The actuator for a variable compression ratio mechanism of an internal combustion engine includes an electric motor; a control shaft to which a rotative force from the electric motor is transmitted, the control shaft including a first journal portion and a second journal portion; an arm link portion that is disposed between the first journal portion and the second journal portion in an axial direction and extends from the control shaft in a radial direction, where the axial direction is a direction along a rotational axis line of the control shaft, and the radial direction is a radiation direction of the rotational axis line, the arm link portion being linked to the variable compression ratio mechanism of the internal combustion engine; a first housing including an accommodation chamber that accommodates the arm link portion, a radial opening portion that opens from the accommodation chamber in the radial direction, and a first opening portion that opens from the accommodation chamber toward the first journal portion side in the axial direction; and a second housing that closes the first opening portion, the second housing including a first bearing portion that supports the first journal portion.

### TECHNICAL FIELD

The invention relates to an actuator for a variable compression ratio mechanism of an internal combustion engine.

### BACKGROUND ART

Patent Literature 1 discloses an actuator for a variable compression ratio mechanism of an internal combustion engine. The actuator has a housing that internally includes an accommodating portion in which a control shaft and an arm link are partially accommodated.

### CITATION LIST

### Patent Literature

PTL 1: Japanese Unexamined Patent Application Publication (Kokai) No. 2015-145647

### SUMMARY OF INVENTION

### Technical Problem

In the above-mentioned conventional actuator, the accommodating portion is formed to extend from one radially lateral surface of the housing relative to the axial direction of the control shaft in a direction traversing the inside of the housing. The accommodating portion therefore has a complex shape, which might deteriorate productivity.

One object of the invention is to provide an actuator for a variable compression ratio mechanism of an internal combustion engine, which improves productivity.

### Solution to Problem

An actuator for a variable compression ratio mechanism of an internal combustion engine according to one embodiment of the invention is so configured that a housing is divided into at least two in an axial direction of a control shaft, and that the housing opens in an axial direction.

A preferred embodiment of the invention thus improves productivity.

### BRIEF DESCRIPTION OF DRAWINGS

FIG. 1 is a schematic diagram of an internal combustion engine including a variable compression ratio device of an internal combustion engine according to an Embodiment 1.

FIG. 2 is a perspective view of an actuator 14 according to the Embodiment 1.

FIG. 3 is a plan view of the actuator 14 according to the Embodiment 1.

FIG. 4 is a left lateral view of the actuator 14 according to the Embodiment 1.

FIG. 5 is a cross-section along line S1-S1 as viewed in a direction of arrows S1, S1 of FIG. 3.

FIG. 6 is a cross-section along line S2-S2 as viewed in a direction of arrows S2, S2 of FIG. 5.

FIG. 7 is a perspective view of a housing 17 as viewed from an X-axis negative direction side according to the Embodiment 1.

FIG. 8 is a rear view of a first housing 27 as viewed from an X-axis positive direction side according to the Embodiment 1.

FIG. 9 is a perspective view of a second housing 28 as viewed from the X-axis negative direction side according to the Embodiment 1.

FIG. 10 is a perspective view of a third housing 29 as viewed from the X-axis positive direction side according to the Embodiment 1.

FIG. 11 is a perspective view of a first housing 36 as viewed from an X-axis negative direction side according to an Embodiment 2.

FIG. 12 is a perspective view of the first housing 36 as viewed from an X-axis positive direction side according to the Embodiment 2.

### DESCRIPTION OF EMBODIMENTS

### Embodiment 1

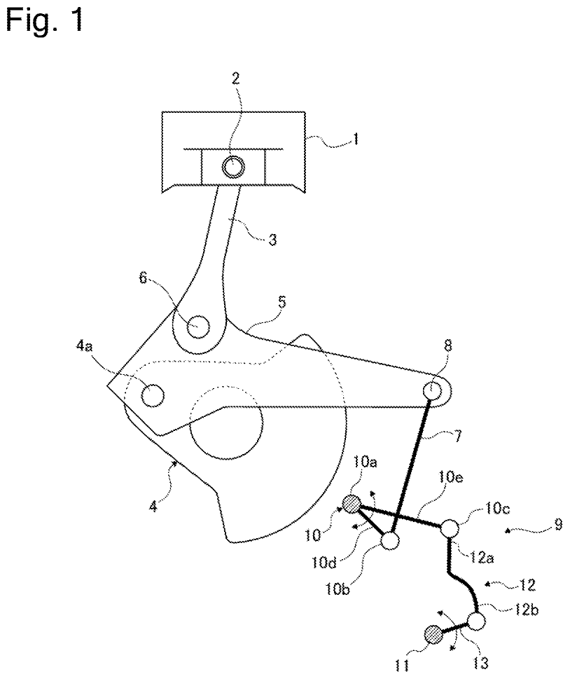

FIG. 1 is a schematic diagram of an internal combustion engine including a variable compression ratio mechanism according to an Embodiment 1. A basic configuration of this variable compression ratio mechanism is similar to the one illustrated in FIG. 1 of the Japanese Unexamined Patent Application Publication (Kokai) No. 2011-169251 and is therefore simply described below.

A piston 1 reciprocates in a cylinder of a cylinder block in an internal combustion engine (gasoline engine). An upper end of an upper link 3 is rotatably coupled to the piston 1 through a piston pin 2. A lower link 5 is rotatably coupled to a lower end of the upper link 3 through a coupling pin 6. A crankshaft 4 is rotatably coupled to the lower link 5 through a crank pin 4a. An upper end portion of a first control link 7 is rotatably coupled to the lower link 5 through a coupling pin 8. A lower end portion of the first control link 7 is coupled to a coupling mechanism 9 including a plurality of links. The coupling mechanism 9 includes a first control shaft 10, a second control shaft (control shaft) 11, a second control link (actuator link) 12, and an arm link portion 13.

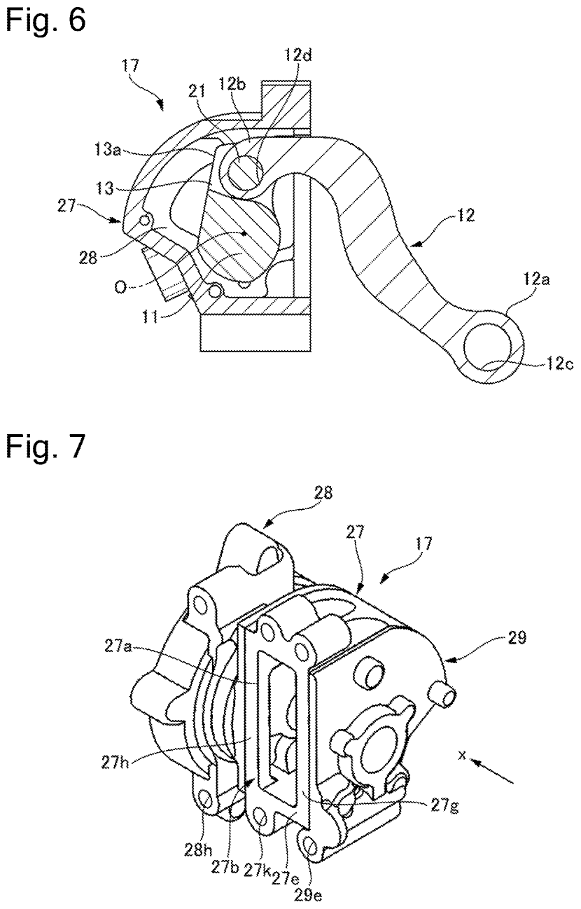

The first control shaft 10 is arranged in parallel with the crankshaft 4. The crankshaft 4 is arranged along a cylinder line direction within the internal combustion engine. The first control shaft 10 includes a first journal portion 10a, a control eccentric shaft portion 10b, an eccentric shaft portion 10c, a first arm portion 10d, and a second arm portion 10e. The first journal portion 10a is rotatably supported by a main body of the internal combustion engine. The control eccentric shaft portion 10b is rotatably coupled to the lower end portion of the first control link 7. The eccentric shaft portion 10c is rotatably coupled to one end portion 12a of the second control link 12. Formed in the one end portion 12a is a communicating hole 12c in which the eccentric shaft portion 10c is rotatably inserted (see FIG. 6). The first arm portion 10d is coupled to the first journal portion 10a at one end. The other end of the first arm portion 10d is coupled to the control eccentric shaft portion 10b. The control eccentric shaft portion 10b is located at a position eccentric to the first journal portion 10a by predetermined amount. The second arm portion 10e is coupled to the first journal portion 10a at one end. The other end of the second arm portion 10e is coupled to the eccentric shaft portion 10c. The eccentric shaft portion 10c is located at a position eccentric to the first journal portion 10a by predetermined amount. The other end portion 12b of the second control link 12 is rotatably coupled to one end of the arm link portion 13. The other end of the arm link portion 13 is coupled to the second control shaft 11. The arm link portion 13 and the second control shaft 11 do not move relative to each other.

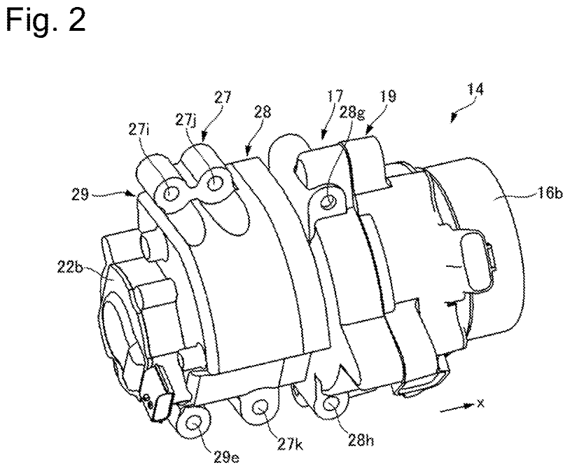

A rotating position of the second control shaft 11 is changed by torque that is transmitted from an actuator 14 as illustrated in FIGS. 2 to 6. The change of the rotating position of the second control shaft 11 rotates the first control shaft 10 through the second control link 12 and changes a position of the lower end portion of the first control link 7. An attitude of the lower link 5 is then changed, which is followed by changes in a stroke position and stroke amount within the cylinder of the piston 1. The engine compression ratio is then accordingly changed.

A configuration of the actuator 14 is described below.

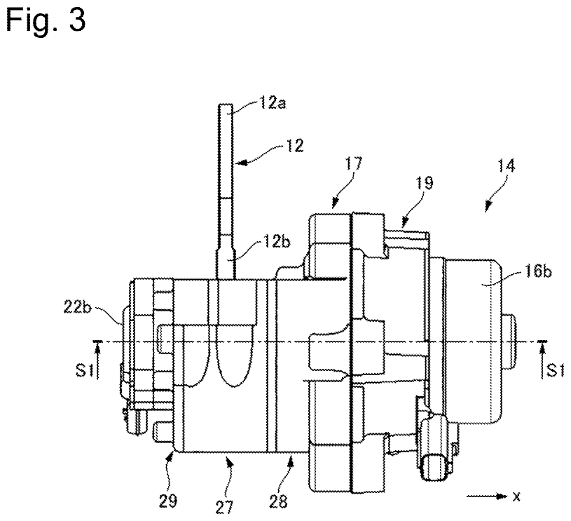

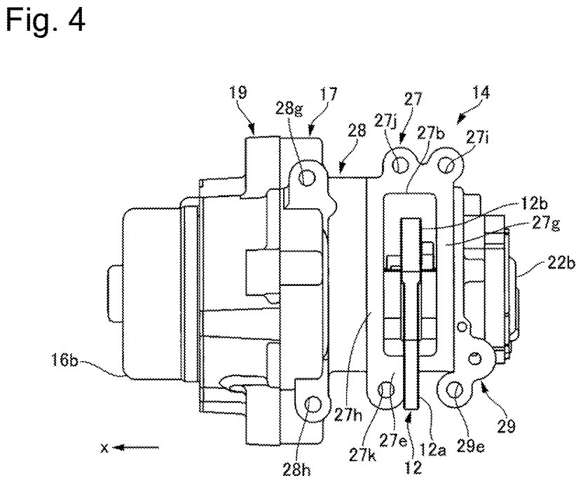

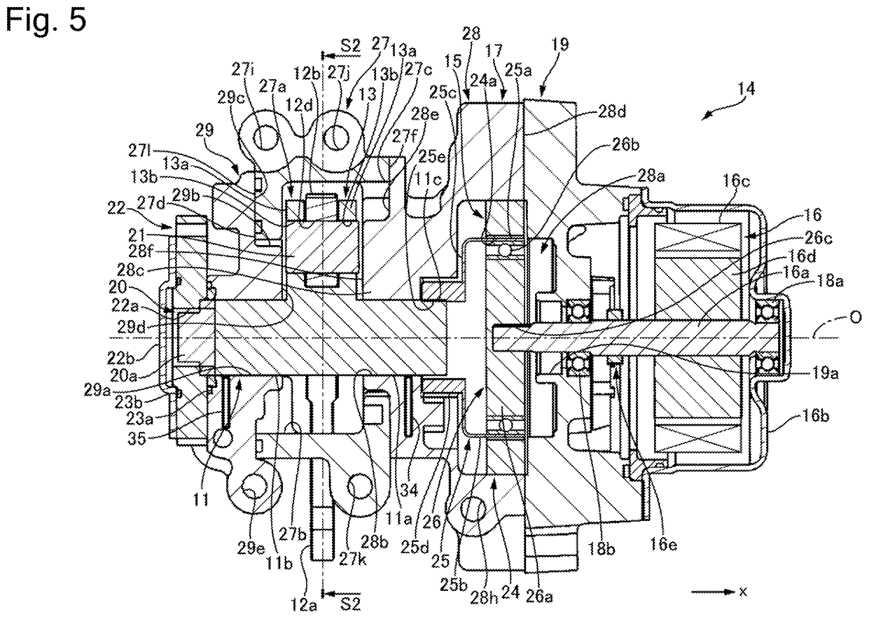

FIG. 2 is a perspective view of the actuator 14 according to the Embodiment 1. FIG. 3 is a plan view of the actuator 14 according to the Embodiment 1. FIG. 4 is a left lateral view of the actuator 14 according to the Embodiment 1. FIG. 5 is a cross-section along line S1-S1 as viewed in a direction of arrows S1, S1 of FIG. 3. FIG. 6 is a cross-section along line S2-S2 as viewed in a direction of arrows S2, S2 of FIG. 5. As illustrated in FIGS. 2 to 6, the actuator for the variable compression ratio mechanism of the internal combustion engine includes an electric motor 16, the second control shaft 11, a wave gear speed reducer 15, and a housing 17. Referring to FIG. 5, a direction in which a rotational axis line 0 of the second control shaft 11 extends (axial direction) is set as an X-axis, and a direction extending from the second control shaft 11 toward the electric motor 16 is defined as an X-axis positive direction. A radiation direction of the rotational axis line 0 and a direction around the rotational axis line 0 are referred to as a radial direction and a circumferential direction, respectively. The wave gear speed reducer 15 is mounted on a motor output shaft 16a of the electric motor 16. The wave gear speed reducer 15 is accommodated inside the housing 17. The second control shaft 11 is rotatably supported by the housing 17.

The electric motor 16 is arranged on an X-axis positive direction side of the wave gear speed reducer 15. The electric motor 16 is a brushless motor and includes the motor output shaft 16a, a motor casing 16b, a coil 16c, a rotor 16d, and a resolver 16e. The motor output shaft 16a has a rotational axis line that coincides with the rotational axis line 0 of the second control shaft 11. The motor output shaft 16a has an X-axis positive direction end that is supported by a ball bearing 18a arranged in a bottom portion of the motor casing 16b. The motor casing 16b is formed into a bottomed cylinder-like shape and fastened to a cover 19 with a screw, not shown. The coil 16c is formed in a cylindrical shape and fixed to an inner circumferential surface of the motor casing 16b. The rotor 16d is rotatably disposed on an inner side of the coil 16c. The resolver 16e detects a rotation angle of the motor output shaft 16a. The resolver 16e is accommodated in the cover 19. The resolver 16e outputs a detection signal to a control unit, not shown, which is accommodated in the motor casing 16b.

The cover 19 is arranged between the housing 17 and the motor casing 16b in an X-axis direction. The cover 19 is molded by metallic mold casting (aluminum die-casting) using an aluminum alloy material. The cover 19 is fastened to the housing 17 and the motor casing 16b with screws, not shown. The cover 19 has a through-hole 19a through which the motor output shaft 16a extends. Arranged in the through-hole 19a is a ball bearing 18b that supports the motor output shaft 16a.

The second control shaft 11 is formed of a ferrous metallic material into a shaft-like shape. The second control shaft 11 is formed integrally with the arm link portion 13. The second control shaft 11 includes a first journal portion 11a and a second journal portion 11b. The first journal portion 11a is located further on the X-axis positive direction side than the arm link portion 13. The second journal portion 11b is located further on an X-axis negative direction side than the arm link portion 13. A rotor 20a of an angle sensor 20 is fixed to an X-axis negative direction end of the second control shaft 11. Formed in an X-axis positive direction end of the second control shaft 11 is a spline shaft portion 11c.

The arm link portion 13 includes two-pronged protruding portions 13a, 13a protruding radially outward. A coupling hole (pin hole) 13b is formed in each of the protruding portions 13a. The other end portion 12b of the second control link 12 is inserted between the protruding portions 13a. A communicating hole 12d is formed in the other end portion 12b. A coupling pin 21 is rotatably inserted in the coupling holes 13b and the communicating hole 12d.

A sensor holder 22 of the angle sensor 20 is fastened on an X-axis negative direction side of the housing 17 with a screw, not shown. The sensor holder 22 has a through-hole 22a. The through-hole 22a has an inner circumferential surface facing an outer circumferential surface of the rotor 20a in the radial direction. A sensing coil is arranged at the inner circumferential surface of the through-hole 22a. The angle sensor 20 detects, through an inductance change of the sensing coil, that preset distance between the inner circumference of the through-hole 22a and the rotor 20a is changed by rotation of the rotor 20a. The angle sensor 20 thus detects a rotation angle of the second control shaft 11. An angle sensor 32 outputs a detection signal to the control unit. A seal ring 23a is installed between the sensor holder 22 and the housing 17. The sensor holder 22 includes a sensor cover 22b that closes the through-hole 22a. A seal ring 23b is installed between the sensor cover 22b and the sensor holder 22.

The wave gear speed reducer 15 is accommodated in the housing 17. The wave gear speed reducer 15 includes a rigid internal gear 24, a flexible external gear 25, and a wave generator 26.

The rigid internal gear 24 is a rigid-body annular member including a plurality of internal teeth 24a. The internal teeth 24a are arranged on an inner circumference of the rigid internal gear 24. The rigid internal gear 24 is fixed to the housing 17.

The flexible external gear 25 is arranged on a radially inner side of the rigid internal gear 24. The flexible external gear 25 is formed of a metallic material and includes a cylinder portion 25b and an inner flange portion 25c. The cylinder portion 25b is formed into a thin-walled cylinder that is flexibly deformable. The cylinder portion 25b includes external teeth 25a arranged on one axial end side of an outer circumferential surface thereof. The external teeth 25a are meshed with the internal teeth 24a of the rigid internal gear 24. The number of the external teeth 25a is two teeth less than the number of the internal teeth 24a. The inner flange portion 25c extends radially inward from the other axial end side of the cylinder portion 25b. A small-diameter cylinder portion 25d is formed in an inner circumference of the inner flange portion 25c. The cylinder portion 25d has a spline hole 25e. The spline hole 25e is splined to the spline shaft portion 11c of the second control shaft 11. The flexible external gear 25 is rotated integrally with the second control shaft 11.

The wave generator 26 has an outer circumferential surface that slides along an inner circumferential surface of the flexible external gear 25. The wave generator 26 includes a wave generation plug 26a and a ball bearing 26b. The wave generation plug 26a has an elliptical cross-section along a direction orthogonal to a rotational axis line thereof. The wave generation plug 26a has an elliptical profile including a long shaft portion having a largest radius and a short shaft portion having a smallest radius with the rotational axis line 0 serving as a center. A through-hole 26c is formed in a radial center of the waver generation plug 26a. The motor output shaft 16a is press-fitted in the through-hole 26c. The wave generator 26 is rotated integrally with the motor output shaft 16a. The ball bearing 26b allows relative rotation between the outer circumference of the wave generation plug 26a and the inner circumference of the flexible external gear 25.

The housing 17 includes a first housing 27, a second housing 28, and a third housing 29. The housings 27, 28 and 29 are arranged in a line in the order of the third housing 29, the first housing 27, and the second housing 28 from the X-axis negative direction side toward the X-axis positive direction side. The housings 27, 28 and 29 are fastened together with bolts. The housings 27, 28 and 29 are molded by metallic mold casting (aluminum die-casting) using an aluminum alloy material.

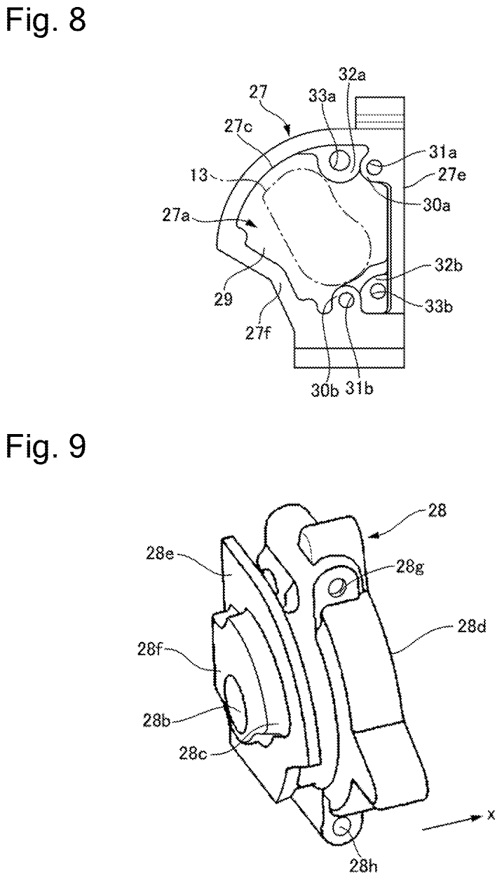

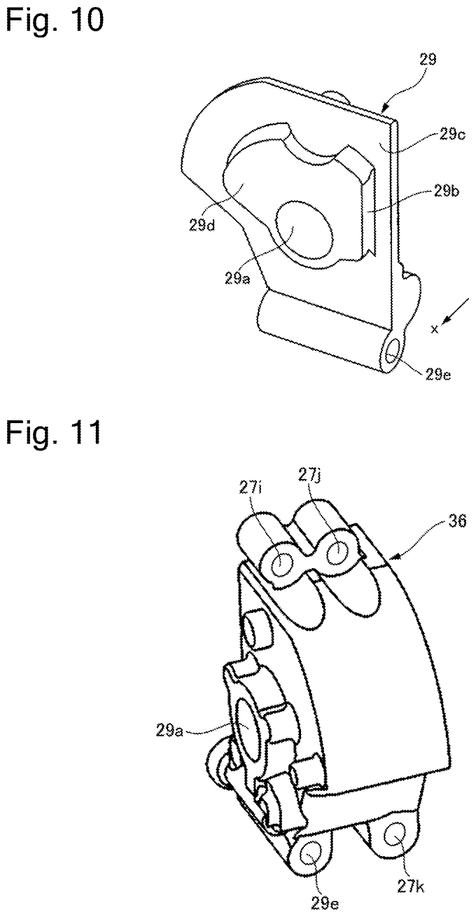

FIG. 7 is a perspective view of the housing 17 as viewed from the X-axis negative direction side according to the Embodiment 1. FIG. 8 is a view of the first housing 27 as viewed from the X-axis positive direction side according to the Embodiment 1. FIG. 9 is a perspective view of the second housing 28 as viewed from the X-axis negative direction side according to the Embodiment 1. FIG. 10 is a perspective view of the third housing 29 as viewed from the X-axis positive direction side according to the Embodiment 1.

The first housing 27 includes an arm link accommodation chamber (accommodation chamber) 27a, a radial opening portion 27b, a first opening portion 27c, and a second opening portion 27d.

The arm link accommodation chamber 27a is formed inside the first housing 27 and accommodates the arm link portion 13.

The radial opening portion 27b is formed at a central position of a left lateral surface 27e of the first housing 27 and leads the arm link accommodation chamber 27a to the outside. The left lateral surface 27e is formed into a flat surface. An edge portion of the radial opening portion 27b in the left lateral surface 27e functions as a seal surface that comes into contact with the internal combustion engine to close the radial opening portion 27b when the actuator 14 is mounted on the internal combustion engine.

The first opening portion 27c is formed at a central position of a rear surface 27f of the first housing 27 and leads the arm link accommodation chamber 27a to the outside. The rear surface 27f is formed into a flat surface. A first beam portion 27g that is a part of an edge portion of the first opening portion 27c and extends in a vertical direction forms a part of the edge portion of the radial opening portion 27b. A ring-like seal, not shown, is arranged in the edge portion of the first opening portion 27c.

The second opening portion 27d is formed at a central position of a front surface 271 of the first housing 27 and leads the arm link accommodation chamber 27a to the outside. The front surface 271 is formed into a flat surface. A second beam portion 27h that is a part of an edge portion of the second opening portion 27d and extends in the vertical direction forms a part of the edge portion of the radial opening portion 27b. A ring-like seal, not shown, is arranged in the edge portion of the second opening portion 27d.

As illustrated in FIG. 8, the edge portion of the first opening portion 27c includes two convex portions 30a and 30b extending radially inward. Formed in the convex portions 30a and 30b are bolt holes 31a and 31b, respectively, for fastening the convex portions 30a and 30b to the second housing 28. The edge portion of the second opening portion 27d similarly includes two convex portions 32a and 32b extending radially inward. Formed in the convex portions 32a and 32b are bolt holes 33a and 33b, respectively, for fastening the convex portions 32a and 32b to the third housing 29. The first opening portion 27c is large enough in size to allow the arm link portion 13 to be inserted therein.

The first housing 27 includes bolt holes 27i, 27j and 27k for fastening the first housing 27 to the internal combustion engine side (for example, oil pan).

The second housing 28 includes a speed reducer accommodation chamber 28a, a first bearing portion 28b, and a first extending portion 28c.

The speed reducer accommodation chamber 28a is a concave portion that is formed at a central position of a rear surface 28d of the second housing 28. The speed reducer accommodation chamber 28a accommodates the wave gear speed reducer 15. The speed reducer accommodation chamber 28a is closed by the cover 19.

The first bearing portion 28b rotatably supports the first journal portion 11a of the second control shaft 11. Lubricating oil that is pneumatically transported from an oil pump, not shown, is introduced between the first bearing portion 28b and the first journal portion 11a through a lubricating oil feeding passage 34 formed inside the second housing 28. The first bearing portion 28b extends from the speed reducer accommodation chamber 28a toward the X-axis negative direction side and opens into a front surface 28e of the second housing 28. The front surface 28e contacts the rear surface 27f of the first housing 27.

The first extending portion 28c is a convex portion extending from the front surface 28e toward the X-axis negative direction side. The first extending portion 28c extends farther toward the X-axis negative direction side than the rear surface 27f of the first housing 27. A distal end surface 28f of the first extending portion 28c is formed into a flat surface and located further on the X-axis negative direction side than the convex portions 30a and 30b. The distal end surface 28f faces the coupling pin 21 with predetermined clearance in the X-axis direction. The first extending portion 28c has such a shape as to at least partially overlap (overlapping) the arm link portion 13 as viewed from the X-axis direction. The first extending portion 28c has such a shape as to at least partially overlap the coupling pin 21 whatever possible position the coupling pin 21 takes according to the rotation angle of the second control shaft 11 as viewed from the X-axis direction. The first extending portion 28c does not overlap the convex portions 30a and 30b as viewed from the X-axis direction. The first extending portion 28c has a radial cross-sectional shape including concave portions that follow the shapes of the convex portions 30a and 30b so as not to interfere with the convex portions 30a and 30b.

The second housing 28 includes bolt holes 28g and 28h for fastening the second housing 28 to the internal combustion engine side (for example, oil pan).

The third housing 29 includes a second bearing portion 29a and a second extending portion 29b.

The second bearing portion 29a rotatably supports the second journal portion 11b of the second control shaft 11. The second bearing portion 29a extends through the third housing 29 in the X-axis direction and opens into a rear surface 29c of the third housing 29. Lubricating oil that is pneumatically transported from an oil pump, not shown, is introduced between the second bearing portion 29a and the second journal portion 11b through a lubricating oil feeding passage 35 formed inside the third housing 29. The rear surface 20c contacts the front surface 271 of the first housing 27.

The second extending portion 29b is a convex portion extending from the rear surface 29c toward the X-axis positive direction side. The second extending portion 29b extends farther toward the X-axis positive direction side than the front surface 271 of the first housing 27. The second extending portion 29b has a distal end surface 29d that is formed into a flat surface and located further on the X-axis positive direction side than the convex portions 32a and 32b. The distal end surface 29d faces the coupling pin 21 with predetermined clearance in the X-axis direction. The second extending portion 29b has such a shape as to at least partially overlap (overlapping) the arm link portion 13 as viewed from the X-axis direction. The second extending portion 29b has such a shape as to at least partially overlap the coupling pin 21 whatever possible position the coupling pin 21 takes according to the rotation angle of the second control shaft 11 as viewed from the X-axis direction. The second extending portion 29b does not overlap the convex portions 32a and 32b as viewed from the X-axis direction. That is, the second extending portion 29b has a radial cross-sectional shape including concave portions that follow the shapes of the convex portions 32a and 32b so as not to interfere with the convex portions 32a and 32b.

The third housing 29 includes a bolt hole 29e for fastening the third housing 29 to the internal combustion engine side (for example, oil pan).

Operation and advantageous effects of the Embodiment 1 are now described.

In the actuator 14 of the Embodiment 1, the housing 17 includes the first housing 27 including the arm link accommodation chamber 27a and the second housing 28 including the first bearing portion 28b that supports the first journal portion 11a of the second control shaft 11a. The arm link accommodation chamber 27a opens through the first opening portion 27c formed on the X-axis positive direction side of the first housing 27. The first opening portion 27c is closed by the second housing 28. The first housing 27 that internally includes the arm link accommodation chamber 27a opens in the X-axis direction. As compared to an integral housing, therefore, the Embodiment 1 simplifies a mold used in metallic mold casting and facilitates processing, thereby improving productivity. Since the arm link accommodation chamber 27a and the first bearing portion 28b are not divided, sealing performance between the arm link accommodation chamber 27a and the first bearing portion 28b is improved, and the first bearing portion 28b is also improved in durability, as compared to a case where the arm link accommodation chamber and the first bearing portion are divided in the axial or radial direction. The edge portion of the radial opening portion 27b in the left lateral surface 27e contacts the internal combustion engine and thus functions as the seal surface that closes the radial opening portion 27b when the actuator 14 is mounted on the internal combustion engine. To that end, no divided surface is provided in the edge portion. This restrains a deterioration in sealing performance when the actuator 14 is mounted on the internal combustion engine. In other words, the housing 17 is divided into the first housing 27 and the second housing 28 with the radial opening portion 27b remaining. The radial opening portion 27b is formed in a continuous manner to have the annular shape as the seal surface against the internal combustion engine. Therefore, the deterioration of sealing performance is restrained, and productivity is improved. Since the first bearing portion 28b is formed integrally with the second housing 28, the second housing 28 not only closes the first opening portion 27c but also has an effect of axially supporting the second control shaft 11a.

The first housing 27 includes the first beam portion 27g that is a part of the edge portion of the radial opening portion 27b and a part of the edge portion of the first opening portion 27c. The edge portion of the radial opening portion 27b in the left lateral surface 27e of the first housing 27 functions as the seal surface when the first housing 27 is mounted on the internal combustion engine. In this view, if the first beam portion 27g is divided, the seal surface is divided, and there is a possibility of leakage. If the first beam portion 27g is located on the first housing 27 side, the deterioration of sealing performance is restrained.

The second housing 28 includes the first extending portion 28c extending inward in the radial direction of the first opening portion 27c. The first extending portion 28c has such a shape as to overlap the coupling pin 21 that couples the arm link portion 13 and the second control link 12 in a relatively rotatable manner whatever possible position the coupling pin 21 takes according to the rotation angle of the second control shaft 11 as viewed from the X-axis direction. While the coupling pin 21 is movable in the X-axis direction, the distal end surface 28f of the first extending portion 28c functions as a thrust receiver for the coupling pin 21, preventing the coupling pin 21 from falling out. The second control shaft 11 is rotated within a predetermined angle range (for example, approximately 150 degrees), so that the coupling pin 21 is unevenly abraded if the coupling pin 21 is press-fitted in the coupling holes 13b or the communication hole 12d. If the first extending portion 28c functions as a thrust receiver of the coupling pin 21, the coupling pin 21 does not have to be press-fitted, which prevents the uneven abrasion of the coupling pin 21. The unnecessity of press-fitting of the coupling pin 21 improves workability in assembly. In addition, the first extending portion 28c protrudes farther outward than the front surface 28e of the second housing 28, which makes processing easier, as compared to a case in which a thrust receiver for a coupling pin is formed inside an integrally-formed housing.

The first housing 27 includes the convex portions 30a and 30b extending radially inward from the edge portion of the first opening portion 27c. The convex portions 30a and 30b have the bolt holes 31a and 31b for fastening the convex portions 30a and 30b to the second housing 28. Since fastening points are located on a radially inner side of the edge portion of the first opening portion 27c, the housing 17 is downsized and lightened in weight, as compared to a case in which convex portions are formed on a radially outer side of the edge portion to function as fastening points. The absence of a fastening point in the edge portion of the first opening portion 27c prevents the annular seal from being formed into a complicated shape to avoid the fastening point when the seal is arranged in the edge portion of the first opening portion 27c.

The first extending portion 28c has a radial cross-sectional shape that follows the shapes of the convex portions 30a and 30b. This makes it possible to avoid interference between the first extending portion 28c on one hand and the convex portions 30a and 30b on the other when the first housing 27 and the second housing 28 are assembled together.

The first extending portion 28c extends farther toward the X-axis negative direction side than the convex portions 30a and 30b in the X-axis direction. The first extending portion 28c then prevents the coupling pin 21 from falling out as the thrust receiver for the coupling pin 21 while avoiding the interference with the convex portions 30a and 30b.

The first extending portion 28c has such a shape as to overlap the arm link portion 13 as viewed from the X-axis direction. The distal end surface 28f of the first extending portion 28c thus functions as a thrust receiver for the arm link portion 13. A thrust force acting on the arm link portion 13 is received by the second housing 28, which improves the arm link portion 13 in durability. If a divided surface between the first housing and the second housing overlaps the radial opening portion of the first housing, the seal surface (edge portion of the radial opening portion) used when the radial opening portion is fixed to the internal combustion engine is divided, and the sealing performance is not be ensured. In contrast, if the second housing 28 includes the first extending portion 28c extending toward an inner periphery of the first opening portion 27c, it is possible to ensure the seal surface against the internal combustion engine and provide the thrust receiver for the arm link portion 13.

The first opening portion 27c is large enough in size to allow the arm link portion 13 to be inserted therein. The second control shaft 11 formed integrally with the arm link portion 13 therefore can be assembled inside the arm link accommodation chamber 27a through the first opening portion 27c. This improves workability in assembly. If the arm link portion 13 is a separate body from the second control shaft 11, the second control shaft 11 is press-fitted in the arm link portion 13, and thereafter, the arm link portion 13 and the second control shaft 11 as one integral body can be assembled inside the arm link accommodation chamber 27a. It is then unnecessary to press-fit the second control shaft 11 in the arm link portion 13 within the arm link accommodation chamber 27a, which improves the workability in assembly.

The integral formation of the second control shaft 11 and the arm link portion 13 eliminates the necessity of press-fitting the second control shaft 11 in the arm link portion 13 and improves the workability in assembly.

In the actuator 14 according to the Embodiment 1, the housing 17 comprises the first housing 27 including the arm link accommodation chamber 27a, and the third housing 29 including the second bearing portion 29a that supports the second journal portion 11b of the second control shaft 11a. The arm link accommodation chamber 27a opens through the second opening portion 27d formed on the X-axis negative direction side of the first housing 27. The second opening portion 27d is closed by the third housing 29. The first housing 27 that internally includes the arm link accommodation chamber 27a opens in the X-axis direction. This simplifies the mold used in metallic mold casting and facilitates processing, thereby improving productivity, as compared to an integrally-formed housing. Since the arm link accommodation chamber 27a and the second bearing portion 29a are not divided, the sealing performance between the arm link accommodation chamber 27a and the second bearing portion 29a is improved, and the second bearing portion 29a is also improved in durability, as compared to a case in which the arm link accommodation chamber 27a and the second bearing portion 29a are divided.

The first housing 27 includes the second beam portion 27h that is a part of the edge portion of the radial opening portion 27b and a part of the edge portion of the second opening portion 27d. If the second beam portion 27h is divided, the seal surface is divided, and there is a possibility of leakage. If the second beam portion 27h is located on the first housing 27 side, the deterioration of sealing performance is restrained.

The third housing 29 includes the second extending portion 29b extending toward a radially inner side of the second opening portion 27d. The second extending portion 29b has such a shape as to overlap the coupling pin 21 whatever possible position the coupling pin 21 takes according to the rotation angle of the second control shaft 11 as viewed from the X-axis direction. The distal end surface 29d of the second extending portion 29d functions as a thrust receiver for the coupling pin 21, preventing the coupling pin 21 from falling out. Since the second extending portion 29b functions as the thrust receiver for the coupling pin 21, the coupling pin 21 does not have to be press-fitted, which prevents the uneven abrasion of the coupling pin 21. The elimination of press-fitting of the coupling pin 21 improves the workability in assembly. In addition, the second extending portion 29b protrudes farther outward than the rear surface 29c of the third housing 29, so that the processing is easier, as compared to a case in which a thrust receiver for a coupling pin is formed inside the integrally-formed housing.

The second extending portion 29b has such a shape as to overlap the arm link portion 13 as viewed from the X-axis direction. The distal end surface 29d of the second extending portion 29b thus functions as a thrust receiver for the arm link portion 13. A thrust force acting on the arm link portion 13 is therefore received by the third housing 29. This improves the arm link portion 13 in durability. If a divided surface between the first housing and the third housing overlaps the radial opening portion of the first housing, the seal surface (edge portion of the radial opening portion) used when the radial opening portion is fixed to the internal combustion engine is divided, and the sealing performance is not be ensured. In contrast, if the third housing 29 includes the second extending portion 29b extending toward an inner periphery of the second opening portion 27d, it is possible to ensure the seal surface against the internal combustion engine and provide the thrust receiver for the arm link portion 13.

### Embodiment 2

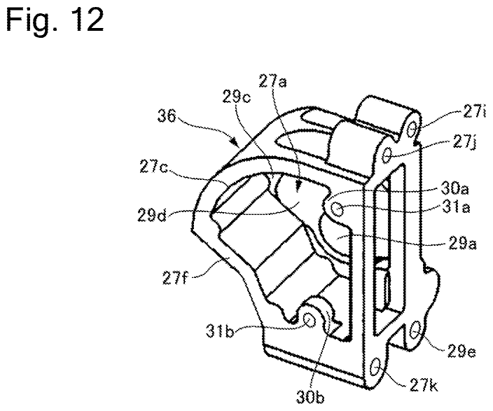

FIG. 11 is a perspective view of a first housing 36 as viewed from an X-axis negative direction side according to an Embodiment 2. FIG. 12 is a perspective view of the first housing 36 as viewed from an X-axis positive direction side according to the Embodiment 2.

The first housing 36 is obtained by integrally molding the first housing 27 and the second housing 29 of the Embodiment 1 through metallic mold casting. A second housing 28 is similar to the second housing 28 of the Embodiment 1 and therefore omitted from the drawings.

According to the Embodiment 2, the first housing 36 includes a second bearing portion 29a that axially supports a second journal portion 11b of a second control shaft 11. The number of divided surfaces of a housing 17 is less than in the Embodiment 1, which improves sealing performance. The number of parts is accordingly reduced, which facilitates parts management.

The first housing 36 includes a distal end surface (sliding surface) 29d that is contactable with a coupling pin 21 in an X-axis direction. The distal end surface 29d thus functions as a thrust receiver for the coupling pin 21 and prevents the coupling pin 21 from falling out. Since the distal end surface 29d functions as the thrust receiver for the coupling pin 21, the coupling pin 21 does not have to be press-fitted and is prevented from being unevenly abraded. The unnecessity of press-fitting of the coupling pin 21 improves workability in assembly.

The first housing 36 includes the distal end surface (sliding surface) 29d that is contactable with an arm link portion 13 in the X-axis direction. The distal end surface 29d thus functions as a thrust receiver for the arm link portion 13. A thrust force acting on the arm link portion 13 therefore can be received by the first housing 36. This improves the arm link portion 13 in durability.

### Other Embodiments

The embodiments for carrying out the invention have been described. Specific configurations of the invention are not limited to the configurations of the embodiments. The invention may be altered in design or the like without deviating from the gist thereof. The constituent elements mentioned in the claims and description may be combined in any ways or omitted within a scope where the aforementioned problem can be at least partially solved or a scope where the advantageous effects are at least partially provided.

For example, the first housing 27 and the second housing 28 of the Embodiment 1 may be integrally formed, and the only third housing 29 may be formed as a separate body. In such a case, the second opening portion 27d of the third housing 29 is formed large enough in size to allow the arm link portion 13 to be inserted therein.

The second control shaft 11 and the arm link portion 13 may be formed into separated bodies.

Other modes that can be understood from the above-described embodiments are discussed below.

An actuator for a variable compression ratio mechanism of an internal combustion engine according to one mode comprises an electric motor; a control shaft to which a rotative force from the electric motor is transmitted, the control shaft including a first journal portion and a second journal portion; an arm link portion disposed between the first journal portion and the second journal portion in an axial direction, extending from the control shaft in a radial direction, and linked to the variable compression ratio mechanism of the internal combustion engine, where the axial direction is a direction along a rotational axis line of the control shaft, and the radial direction is a radiation direction of the rotational axis line; a first housing including an accommodation chamber that accommodates the arm link portion, a radial opening portion that opens from the accommodation chamber in the radial direction, and a first opening portion that opens from the accommodation chamber toward the first journal portion side in the axis direction; and a second housing that closes the first opening portion, the second housing including a first bearing portion that supports the first journal portion.

In another mode according to the above-described mode, the first housing includes a first beam portion that forms a part of an edge portion of the radial opening portion and a part of an edge portion of the first opening portion.

In another mode according to either one of the above-described modes, the actuator includes an actuator link that is linked to the variable compression ratio mechanism. The arm link portion includes a pin hole on an outer end in the radial direction and is arranged to be rotatable relative to the actuator link through a pin inserted in the pin hole. The second housing includes a first extending portion extending inward in the radial direction of the first opening portion. The first extending portion overlaps the pin as viewed from the axial direction.

In still another mode according to any one of the above-described modes, the first extending portion overlaps the pin at any position within a rotatable range of the control shaft as viewed from the axial direction.

In still another mode according to any one of the above-described modes, the first housing includes a convex portion extending inward in the radial direction from the edge portion of the first opening portion. The convex portion has a bolt hole for fastening the convex portion and the second housing.

In still another mode according to any one of the above-described modes, the first extending portion has a cross-sectional shape along the radial direction, which follows a shape of the convex portion.

In still another mode according to any one of the above-described modes, the first extending portion extends farther toward the arm link portion side than the convex portion in the axial direction.

In still another mode according to any one of the above-described modes, the second housing includes a first extending portion extending inward in the radial direction of the first opening portion. The first extending portion overlaps the arm link portion as viewed from the axial direction.

In still another mode according to any one of the above-described modes, the first opening portion is large enough in size to allow the arm link portion to be inserted in the first opening portion.

In still another mode according to any one of the above-described modes, the control shaft and the arm link portion are integrally formed.

In still another mode according to any one of the above-described modes, the first housing includes a second opening portion that opens from the accommodation chamber toward the second journal portion side in the axial direction. The actuator comprises a third housing that closes the second opening portion, the third housing including a second bearing portion that supports the second journal portion.

In still another mode according to any one of the above-described modes, the first housing includes a second beam portion that forms a part of the edge portion of the radial opening portion and a part of an edge portion of the second opening portion.

In still another mode according to any one of the above-described modes, the actuator includes the actuator link that is linked to the variable compression ratio mechanism. The arm link portion includes the pin hole on the outer end in the radial direction and is arranged to be rotatable relative to the actuator link through a pin inserted in the pin hole. The third housing includes the second extending portion extending inward in the radial direction of the second opening portion. The second extending portion overlaps the pin as viewed from the axial direction.

In still another mode according to any one of the above-described modes, the second extending portion overlaps the pin at any position within the rotatable range of the control shaft as viewed from the axial direction.

In still another mode according to any one of the above-described modes, the third housing includes the second extending portion extending inward in the radial direction of the second opening portion. The second extending portion overlaps the arm link portion as viewed from the axial direction.

In still another mode according to any one of the above-described modes, the first housing includes the second bearing portion that supports the second journal portion.

In still another mode according to any one of the above-described modes, the actuator includes the actuator link that is linked to the variable compression ratio mechanism. The arm link portion includes the pin hole on the outer end in the radial direction and is arranged to be rotatable relative to the actuator link through the pin extending through the pin hole. The first housing includes a sliding surface that is contactable with the pin in the axial direction.

In still another mode according to any one of the above-described modes, the first housing includes a sliding surface that is contactable with the arm link portion in the axial direction.

From another perspective according to one mode, an actuator for a variable compression ratio mechanism of an internal combustion engine comprises an actuator link that is linked to a variable compression ratio mechanism of the internal combustion engine and changes an attitude of the variable compression ratio mechanism of the internal combustion engine; a control shaft formed into a shaft-like shape, the control shaft including an arm link portion that protrudes outward in a radial direction and is coupled to the actuator link in a relatively rotatable manner, where the radial direction is a radiation direction of a rotational axis line of the control shaft; a first housing including an accommodating portion that accommodates the arm link portion, a radial opening portion that opens from the accommodating portion in the radial direction, an edge portion of the radial opening portion, which comes into contact with the internal combustion engine and thus functions as a seal surface when the actuator is mounted on the internal combustion engine, and a first opening portion that opens from the accommodating portion in a direction along the rotational axis line of the control shaft, the first opening portion in which the arm link portion is insertable; and a second housing that closes the first opening portion and supports the control shaft.

The present application claims priority under Japanese Patent Application No. 2017-176957 filed on Sep. 14, 2017. The entire disclosure of Japanese Patent Application No. 2017-176957 filed on Sep. 14, 2017 including the description, claims, drawings and abstract, is incorporated herein by reference in its entirety.

### REFERENCE SIGNS LIST

11 Second control shaft (control shaft)
11a First journal portion
11b Second journal portion
12 Second control link (actuator link)
13 Arm link portion
13b Coupling hole (pin hole)
14 Actuator
16 Electric motor
21 Coupling pin (pin)
27 First housing
27a Arm link accommodation chamber (accommodation chamber)
27b Radial opening portion
27c First opening portion
27d Second opening portion
27g First beam portion
27h Second beam portion
28 Second housing
28b First bearing portion
28c First extending portion
29 Third housing
29a Second bearing portion
29b Second extending portion
29d Distal end surface (Sliding surface)
30a, 30b Convex portions
31a, 31b Bolt holes
0 Rotational axis line

1. An actuator for a variable compression ratio mechanism of an internal combustion engine comprising:
an electric motor;
a control shaft to which a rotative force from the electric motor is transmitted, the control shaft including a first journal portion and a second journal portion;
an arm link portion that is arranged between the first journal portion and the second journal portion in an axial direction and extends from the control shaft in a radial direction, where the axial direction is a direction along a rotational axis line of the control shaft, and the radial direction is a radiation direction of the rotational axis line, the arm link portion being linked to a variable compression ratio mechanism of the internal combustion engine;
a first housing including an accommodation chamber that accommodates the arm link portion, a radial opening portion that opens from the accommodation chamber in the radial direction, and a first opening portion that opens from the accommodation chamber toward the first journal portion side in the axial direction; and
a second housing that closes the first opening portion, the second housing including a first bearing portion that supports the first journal portion.

2. The actuator for a variable combustion ratio mechanism of an internal combustion engine according to claim 1,
wherein the first housing includes a first beam portion that forms a part of an edge portion of the radial opening portion and a part of an edge portion of the first opening portion.

3. The actuator for a variable combustion ratio mechanism of an internal combustion engine according to claim 1 comprising:
an actuator link that is linked to the variable compression ratio mechanism,
wherein the arm link portion includes a pin hole on an outer end in the radial direction and is arranged to be rotatable relative to the actuator link through a pin inserted in the pin hole;
wherein the second housing includes a first extending portion extending inward in the radial direction of the first opening portion; and
wherein the first extending portion overlaps the pin as viewed from the axial direction.

4. The actuator for a variable compression ratio mechanism of an internal combustion engine according to claim 3,
wherein the first extending portion overlaps the pin at any position within a rotatable range of the control shaft as viewed from the axial direction.

5. The actuator for a variable combustion ratio mechanism of an internal combustion engine according to claim 3,
wherein the first housing includes a convex portion extending inward in the radial direction from an edge portion of the first opening portion; and
wherein the convex portion includes a bolt hole for fastening the convex portion and the second housing.

6. The actuator for a variable combustion ratio mechanism of an internal combustion engine according to claim 5,
wherein the first extending portion has a cross-sectional shape along the radial direction, which follows a shape of the convex portion.

7. The actuator for a variable combustion ratio mechanism of an internal combustion engine according to claim 6,
wherein the first extending portion extends farther toward the arm link portion side than the convex portion in the axial direction.

8. The actuator for a variable combustion ratio mechanism of an internal combustion engine according to claim 2,
wherein the second housing includes a first extending portion extending inward in the radial direction of the first opening portion; and
wherein the first extending portion overlaps the arm link portion as viewed from the axial direction.

9. The actuator for a variable combustion ratio mechanism of an internal combustion engine according to claim 2,
wherein the first opening portion is large enough in size to allow the arm link portion to be inserted in the first opening portion.

10. The actuator for a variable combustion ratio mechanism of an internal combustion engine according to claim 9,
wherein the control shaft and the arm link portion are integrally formed.

11. The actuator for a variable combustion ratio mechanism of an internal combustion engine according to claim 2,
wherein the first housing includes a second opening portion that opens from the accommodation chamber toward the second journal portion side in the axial direction; and
wherein the actuator comprises a third housing that closes the second opening portion, the third housing including a second bearing portion that supports the second journal portion.

12. The actuator for a variable combustion ratio mechanism of an internal combustion engine according to claim 11,
wherein the first housing includes a second beam portion that forms a part of the edge portion of the radial opening portion and a part of an edge portion of the second opening portion.

13. The actuator for a variable combustion ratio mechanism of an internal combustion engine according to claim 12 comprising:
an actuator link that is linked to the variable compression ratio mechanism,
wherein the arm link portion includes a pin hole on an outer end in the radial direction and is arranged to be rotatable relative to the actuator link through a pin inserted in the pin hole;
wherein the third housing includes a second extending portion extending inward in the radial direction of the second opening portion; and
wherein the second extending portion overlaps the pin as viewed from the axial direction.

14. The actuator for a variable combustion ratio mechanism of an internal combustion engine according to claim 13,
wherein the second extending portion overlaps the pin at any position within a rotatable range of the control shaft as viewed from the axial direction.

15. The actuator for a variable combustion ratio mechanism of an internal combustion engine according to claim 12,
wherein the third housing includes a second extending portion extending inward in the radial direction of the second opening portion;
wherein the second extending portion overlaps the arm link portion as viewed from the axial direction.

16. The actuator for a variable combustion ratio mechanism of an internal combustion engine according to claim 2,
wherein the first housing includes a second bearing portion that supports the second journal portion.

17. The actuator for a variable combustion ratio mechanism of an internal combustion engine according to claim 16 comprising:
an actuator link that is linked to the variable compression ratio mechanism,
wherein the arm link portion includes a pin hole on an outer end in the radial direction and is arranged to be rotatable relative to the actuator link through a pin inserted in the pin hole; and
wherein the first housing includes a sliding surface that is contactable with the pin in the axial direction.

18. The actuator for a variable combustion ratio mechanism of an internal combustion engine according to claim 16,
wherein the first housing includes a sliding surface that is contactable with the arm link portion in the axial direction.

19. An actuator for a variable combustion ratio mechanism of an internal combustion engine comprising:
an actuator link that is linked to a variable compression ratio mechanism of the internal combustion engine and changes an attitude of the variable compression ratio mechanism of the internal combustion engine;
a control shaft formed into a shaft-like shape, the control shaft including an arm link portion that protrudes outward in a radial direction and is coupled to the actuator in a relatively rotatable manner, where the radial direction is a radiation direction of a rotational axis line of the control shaft;
a first housing including an accommodation chamber that accommodates the arm link portion, a radial opening portion that opens from the accommodation chamber in the radial direction, an edge portion of the radial opening portion, which comes into contact with the internal combustion engine and thus functions as a seal surface when the actuator is mounted on the internal combustion engine, and a first opening portion that opens from the accommodating portion in a direction along the rotational axis line of the control shaft, the first opening portion in which the arm ring portion is insertable; and
a second housing that closes the first opening portion and supports the control shaft.
